(19) United States
(12) Patent Application Publication
(10) Pub. No.: US 2020/0310429 A1
(43) Pub. Date: Oct. 1, 2020

(54) DETERMINATION METHOD, DETERMINATION DEVICE, AND RECORDING MEDIUM

(71) Applicant: NEC Corporation, Tokyo (JP)

(72) Inventor: Akihito KOHIGA, Tokyo (JP)

(73) Assignee: NEC Corporation, Tokyo (JP)

(21) Appl. No.: 16/809,113

(22) Filed: Mar. 4, 2020

(30) Foreign Application Priority Data
Mar. 28, 2019 (JP) 2019-063089

(51) Int. Cl. G05D 1/00; G06N 20/00; G06N 5/04; G06Q 10/08; G01P 15/00; G05D 1/02

(52) U.S. Cl. CPC G05D 1/0088; G06N 20/00; G06N 5/04; G05D 2201/0216; G01P 15/00; G05D 1/0221; G06Q 10/0832

(57) ABSTRACT

The present invention relates to a determination method executed by a determination device that determines whether or not an item loaded on a transportation vehicle is being transported stably. The determination method includes: receiving measurement values measured by a sensor installed on the transportation vehicle; and determining whether or not the item is being transported stably by the transportation vehicle based on a degree of stability in stowage representing a degree of stability of the item and based on the received measurement values. The degree of stability in stowage is based on a transportation condition of the transportation vehicle.

### INCORPORATION BY REFERENCE

This application is based upon and claims the benefit of priority from Japanese patent application No. 2019-063089, filed on Mar. 28, 2019, the disclosure of which is incorporated herein in its entirety by reference.

### TECHNICAL FIELD

The present invention relates to a determination method, a determination device, and a recording medium.

### BACKGROUND ART

An automated guided vehicle equipped with a cage trolley may be moved in a state that an item is loaded on the cage trolley.

An example of a technique that can be used for such an automated guided vehicle is described in, for example, Patent Document 1. Patent Document 1 describes an automated guided vehicle that has a distance sensor for detecting the distance between the vehicle body and the floor. According to Patent Document 1, the automated guided vehicle previously learns the state of the floor based on the distance between the vehicle body and the floor detected by the distance sensor. Then, the automated guided vehicle determines the presence/absence of an abnormality of the floor based on the learned state of the floor and the distance information detected by the distance sensor and, in the case of detecting any abnormality, reduces the travel speed. With this, the possibility of a transportation accident is eliminated in advance.

Patent Document 1: Japanese Unexamined Patent Application Publication No. JP-A 2002-347618

For example, depending on how to load an item on a cage trolley, the ease with which the item drops varies even under similar circumstances. However, in a case where only the condition of the floor surface is considered, such as a case where only the distance sensor is used as in Patent Document 1, how to load an item as mentioned above is not considered. Therefore, a problem has arisen that it may be impossible to correctly determine the possibility of a transportation accident.

### SUMMARY OF THE INVENTION

Accordingly, an object of the present invention is to provide a determination method, a determination device, and a recording medium that solve the problem that it is difficult to correctly determine the possibility of a transportation accident when a transportation vehicle moves with an item loaded.

In order to achieve the object, a determination method according to an aspect of the present invention is a determination method executed by a determination device that determines whether or not an item loaded on a transportation vehicle is being transported stably. The determination method includes: receiving measurement values measured by a sensor installed on the transportation vehicle; and determining whether or not the item is being transported stably by the transportation vehicle based on a degree of stability in stowage representing a degree of stability of the item and based on the received measurement values. The degree of stability in stowage is based on a transportation condition of the transportation vehicle.

Further, a determination device according to another aspect of the present invention is a determination device determining whether or not an item loaded on a transportation vehicle is being transported stably. The determination device includes: a reception unit configured to receive measurement values measured by a sensor installed on the transportation vehicle; and a determination unit configured to determine whether or not the item is being transported stably by the transportation vehicle based on a degree of stability in stowage representing a degree of stability of the item and based on the received measurement values. The degree of stability in stowage is based on a transportation condition of the transportation vehicle.

Further, a recording medium according to another aspect of the present invention is a non-transitory computer-readable medium storing a program including instructions for causing a determination device determining whether or not an item loaded on a transportation vehicle is being transported stably to realize: a reception unit configured to receive measurement values measured by a sensor installed on the transportation vehicle; and a determination unit configured to determine whether or not the item is being transported stably by the transportation vehicle based on a degree of stability in stowage representing a degree of stability of the item and based on the received measurement values. The degree of stability in stowage is based on a transportation condition of the transportation vehicle.

With the configurations as described above, the present invention can provide a determination method, a determination device, and a recording medium that solve the problem that it is difficult to correctly determine the possibility of a transportation accident when a transportation vehicle moves with an item loaded.

### BRIEF DESCRIPTION OF DRAWINGS

FIG. 1 is a view showing an example of the overall configuration of an AGV system according to a first example embodiment of the present invention;

FIG. 2 is a side view showing an example of the configuration of an AGV shown in FIG. 1;

FIG. 3 is a block diagram showing an example of components included by an AGV main body shown in FIG. 1;

FIG. 4 is a view showing an example of sensor data used for generation of an evaluation model;

FIG. 5 a view showing an example of the evaluation model;

FIG. 6 is a view for describing an example of a determination process by a determination unit;

FIG. 7 is a view for describing the example of the determination process by the determination unit;

FIG. 8 is a view showing an example of the configuration of a warning device shown in FIG. 1;

FIG. 9 is a flowchart showing an example of an operation of the AGV main body when performing the determination process;

FIG. 10 is a block diagram showing another example of components included by the AGV main body shown in FIG. 1; and

FIG. 11 is a block diagram showing an example of the configuration of a determination device according to a second example embodiment of the present invention.

### EXAMPLE EMBODIMENT

### First Example Embodiment

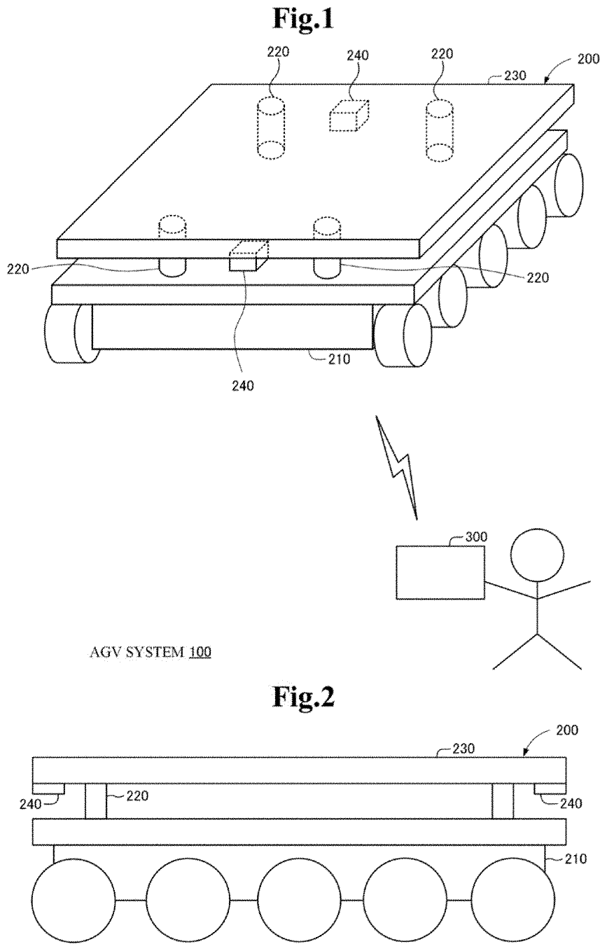

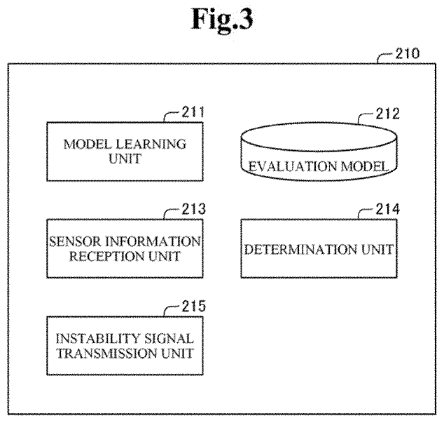

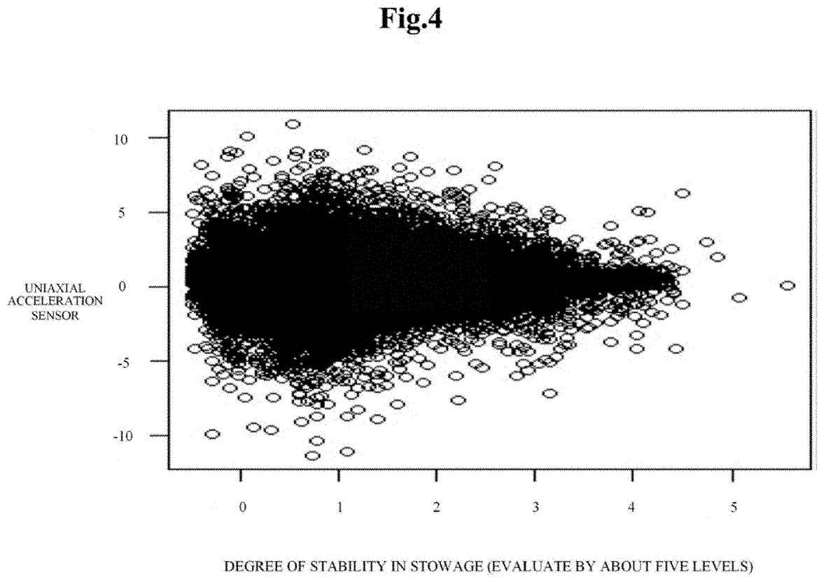

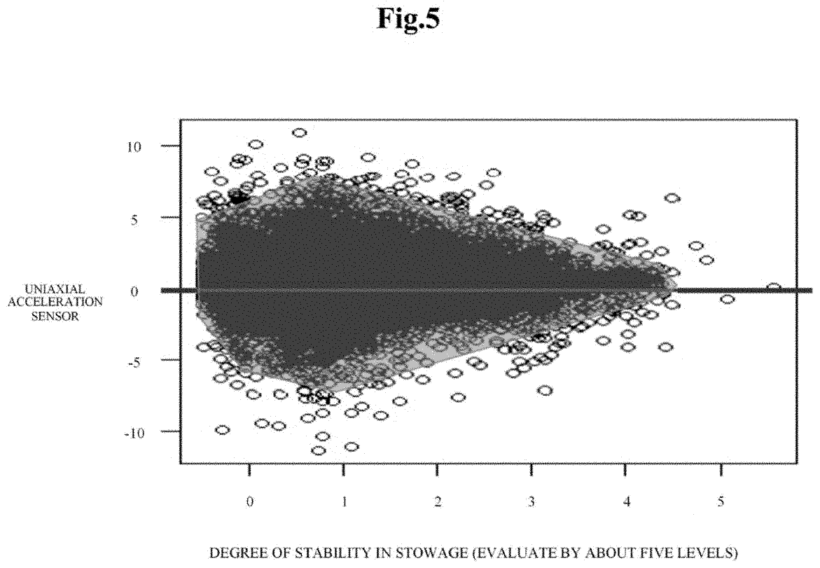

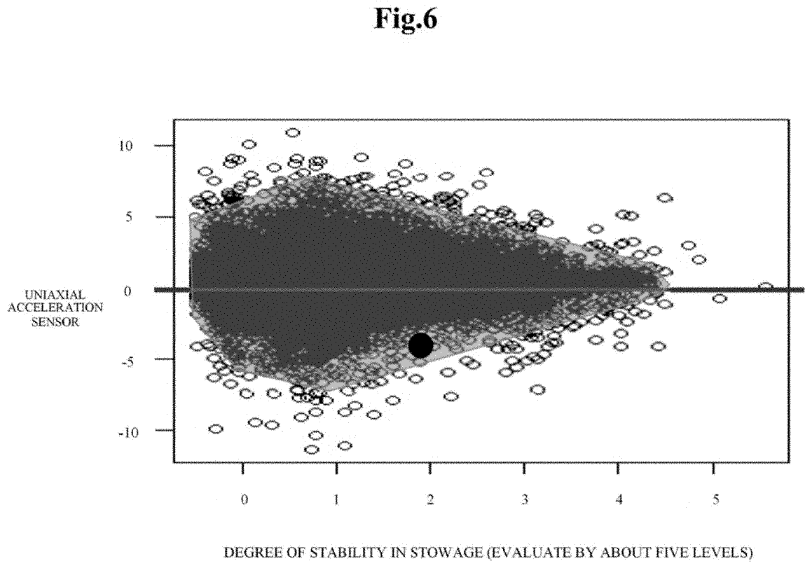

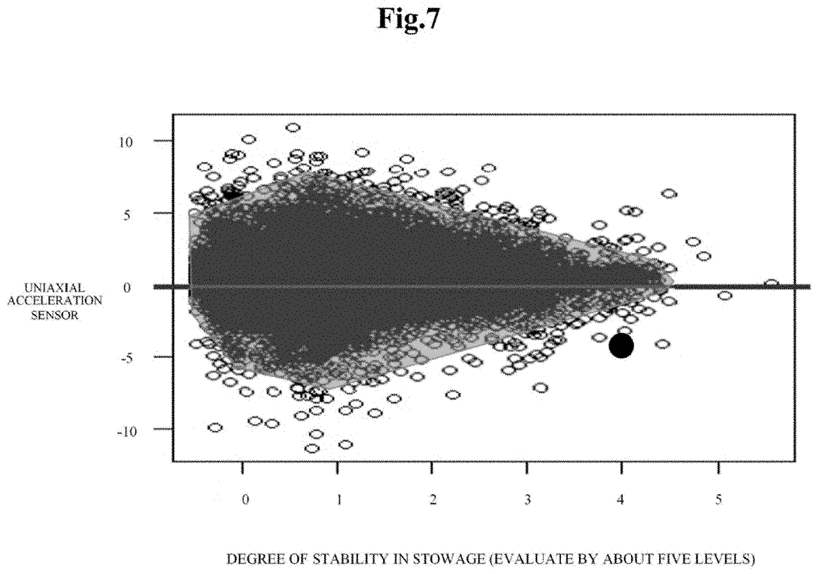

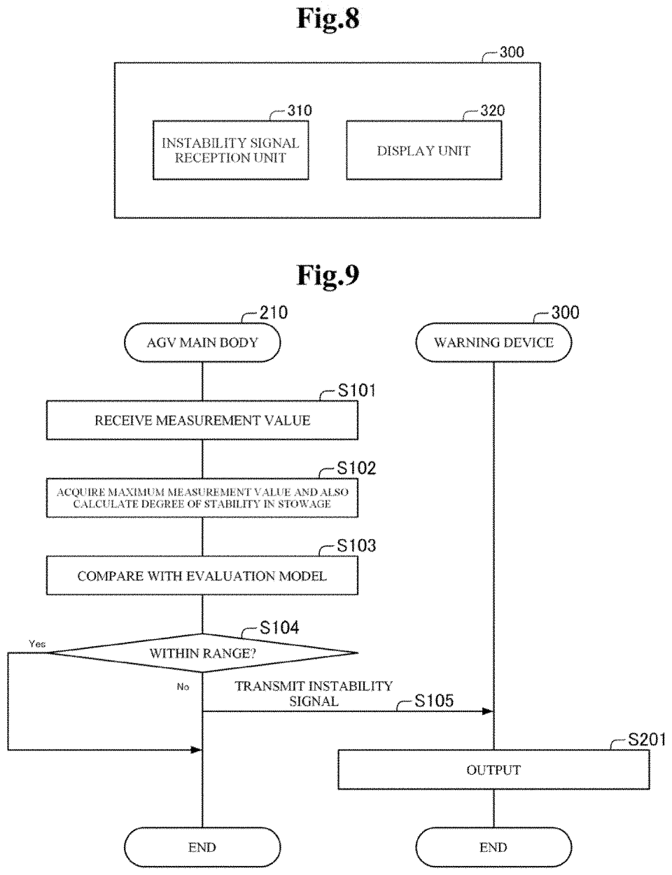

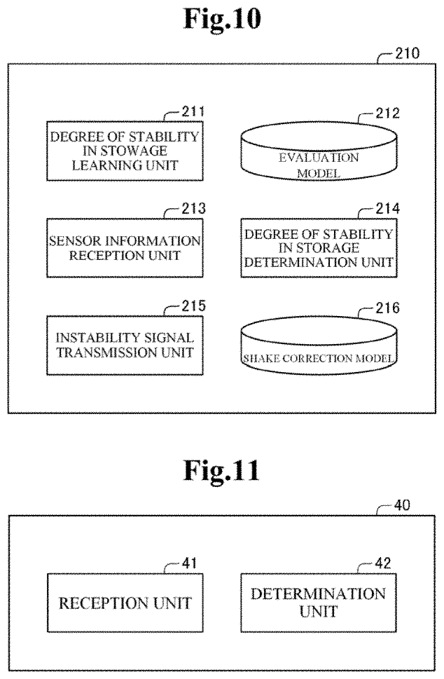

A first example embodiment of the present invention will be described referring to FIGS. 1 to 10. FIG. 1 is a view showing an example of the overall configuration of an AGV system 100. FIG. 2 is a side view showing an example of the configuration of an AGV 200. FIG. 3 is a block diagram showing an example of components included by an AGV main body 210. FIG. 4 is a view showing an example of sensor data used for generation of an evaluation model. FIG. 5 a view showing an example of the evaluation model. FIGS. 6 and 7 are views for describing an example of a determination process by a determination unit 214. FIG. 8 is a view showing an example of the configuration of a warning device 300. FIG. 9 is a flowchart showing an example of an operation of the AGV main body 210 when performing the determination process. FIG. 10 is a block diagram showing another example of components included by the AGV main body 210.

In the first example embodiment of the present invention, the AGV (Automated Guided Vehicle) system 100 that includes the AGV 200 as an unmanned transportation vehicle will be described. The AGV 200 described in this example embodiment has an acceleration sensor 240. As will be described later, the AGV 200 determines whether or not a loaded item is being transported stably based on a maximum measurement value, which is the maximum value of measurement values measured by the acceleration sensor 240, and based on the degree of stability in stowage, which is calculated based on the measurement values. In the case of determining that the item is not being transported stably, the AGV 200 instructs the warning device 300 to reload the item.

The degree of stability in stowage is a value showing the degree of stability of an item loaded on the AGV 200, calculated based on the condition of transportation such as the condition of the item loaded on the AGV 200. The degree of stability in stowage is calculated based on, for example, the degree of dispersion in measurement values measured by the acceleration sensor 240 that are values corresponding to the conditions of items loaded on the AGV 200. For example, the degree of stability in stowage is calculated by calculating a standard deviation of measurement values measured by the acceleration sensor 240 as the degree of dispersion and specifying a range to which the calculated standard deviation belongs of multiple predetermined ranges. For example, the degree of stability in stowage is evaluated in six stages of “0”, “1”, “2”, “3”, “4”, and “5”. In the evaluation in six stages, a smaller numerical value represents a higher degree of stability of an item. The degree of dispersion may be calculated based on a value other than a standard deviation, such as dispersion. Moreover, the degree of stability in stowage may be evaluated in any stages other than six stages. In this example embodiment, a transportation accident refers to trouble in movement of the AGV 200 due to collapse of items loaded on the AGV 200. As will be described later, the AGV 200 in this example embodiment performs determination based on the possibility of collapse of items loaded on the AGV 200 and, when necessary, instructs to reload.

FIG. 1 shows an example of the configuration of the AGV system 100. Referring to FIG. 1, the AGV system 100 includes the AGV 200 and the warning device 300 that is an external device. As shown in FIG. 1, the AGV 200 and the warning device 300 are connected so as to be able communicate with each other by wireless communication.

The configuration of the AGV system 100 is not limited to that illustrated in FIG. 1. For example, the AGV system 100 may include any number of AGVs 200 and warning devices 300. Moreover, FIG. 1 illustrates a case where the warning device 300 is held by an operator who loads or reloads an item. However, a function of the warning device 300 may be included by a control device that directs a movement path to the AGV 200. Besides, for example, in a configuration to automatically load an item with a robot arm or the like, a control device that controls the robot arm may have a function as the warning device 300.

The AGV 200 is a transportation vehicle which can move with an item loaded. FIGS. 1 and 2 show an example of the configuration of the AGV 200. To be specific, FIG. 1 includes a perspective view showing an example of the configuration of the AGV 200, and FIG. 2 is a side view showing an example of the configuration of the AGV 200. Referring to FIGS. 1 and 2, the AGV 200 includes an AGV main body 210, four top board lifers 220, a top board 230, and two acceleration sensors 240.

The AGV main body 210 functions as a determination device that determines whether or not an item loaded on the AGV 200 is being transported stably based on measurement values received from the acceleration sensors 240. As shown in FIGS. 1 and 2, the AGV main body 210 has, for example, a quadrilateral shape in plan view. On the side faces of the AGV main body 210, multiple wheels are installed. The AGV main body 210 can control the movement of the AGV 200 by controlling the wheels.

As shown in FIGS. 1 and 2, the top board lifters 220 are installed around the four corners of the upper surface of the AGV main body 210. The top board lifters 220 are support members that support the top board 230 in a state separated from the AGV main body 210. The top board lifter 220 has, for example, a cylindrical shape. The top board lifter 220 may have a shape other than the shape shown in the drawings, such as a quadrangular prism shape.

The top board 230 has a quadrilateral shape in plan view, similar to that of the AGV main body 210. As mentioned above, the top board 230 is supported in a state separated from the AGV main body 210 by the top board lifters 220 installed at four locations. On the top board 230, a cage trolley on which an item is loaded can be placed. In other words, an item is loaded on the cage trolley placed on the top board 230.

The acceleration sensors 240 are uniaxial acceleration sensors that measure acceleration in the travel direction of the AGV 200. As shown in FIGS. 1 and 2, the acceleration sensors 240 are placed at the front end and the rear end in the travel direction on a surface on the AGV main body 210 side of the top board 230. The acceleration sensors 240 output measurement values as the result of measurement to the AGV main body 210 by wired or wireless communication.

The acceleration sensors 240 do not necessarily need to be uniaxial acceleration sensors. For example, the acceleration sensors 240 may be triaxial acceleration sensors, or the like.

The function of the AGV main body 210 will be described in more detail. FIG. 3 is a block diagram showing an example of components included by the AGV main body 210. Referring to FIG. 3, the AGV 210 includes, for example, a model learning unit 211, an evaluation model 212, a sensor information reception unit 213, a determination unit 214, and an instability signal transmission unit 215 as characteristic components in this example embodiment. For example, the AGV main body part 210 has an arithmetic logic unit such as a CPU (Central Processing Unit) and a storage unit. The AGV main body 210 realizes the respective processing units mentioned above by execution of a program stored in the storage unit by the arithmetic logic unit.

First, of the components included by the AGV main body 210 mentioned above, the model learning unit 211 and the evaluation model 212, which are components relating to advance preprocessing, will be described. The processing by the model learning unit 211 is performed beforehand and, as a result of the processing, the evaluation model 212 is generated.

The model learning unit 211 learns an evaluation model to be used in determining whether or not an item loaded on the AGV 200 is being transported stably, based on measurement values measured by the acceleration sensors 240 at the time of movement of the AGV 200.

For example, by moving the AGV 200 with an item loaded, the AGV main body 210 receives multiple measurement values from the acceleration sensors 240. Then, the AGV main body 210 acquires the maximum measurement value as a value indicating the degree of fluctuation of measurement values based on the received measurement values, and also calculates the degree of stability in stowage based on the degree of dispersion of the measurement values. Moreover, through operation by the operator or the like, a label indicating whether or not to allow the state at the time of moving the AGV 200 is given to the result of the abovementioned calculation. Such processing is repeated while changing the conditions for moving the AGV 200; for example, changing how to load an item, changing the moving speed, and so on. As a result, multiple results are accumulated as shown in FIG. 4.

The model learning unit 211 generates, for example, an evaluation model as shown in FIG. 5 based on the multiple accumulated results as shown in FIG. 4. The example shown in FIG. 5 represents that, in a case where an intersection of the maximum measurement value and the degree of stability in stowage is within a frame shown in FIG. 5, this state is allowed. In the example shown in FIG. 5, in principle, a larger maximum measurement value is allowed as the degree of stability of a loaded item is higher (that is, as the value of the degree of stability in stowage is smaller).

The model learning unit 211 generates, for example, an evaluation model in which a larger maximum measurement value is allowed as the degree of stability of a loaded item is higher as described above. The model learning unit 211 then stores the generated evaluation model into the storage unit.

The model learning unit 211 may be configured to generate an evaluation model by unsupervised learning in which labeling by the operator or the like is not performed. In the case of performing unsupervised learning, the model learning unit 211 generates an evaluation model by generating two clusters by clustering, for example. The model learning unit 211 may generate an evaluation model by a method other than the illustrated method.

The evaluation model 212 is a model that is previously generated and stored into the storage unit by the model learning unit 211. As shown in FIG. 5, an evaluation model represented by the evaluation model 212 is a model in which an allowable maximum measurement value (or a fluctuation range of measurement values) varies in accordance with the degree of stability in stowage. The evaluation model 212 is used by the determination unit 214.

As mentioned above, the evaluation model 212 is previously generated and prepared. Therefore, the AGV main body 210 does not necessarily need to include the model learning unit 211. Even if the AGV main body 210 does not include the model learning unit 211, the AGV main body 210 shall include the evaluation model 212 previously generated by an external model learning unit.

Subsequently, of the components included by the AGV main body 210, the sensor information reception unit 213, the determination unit 214, and the instability signal transmission unit 215 will be described. The sensor information reception unit 213, the determination unit 214, and the instability signal transmission unit 215 are used, for example, in the case of determining whether or not a loaded item is being transported stably when the AGV 200 actually moves with the item loaded.

The sensor information reception unit 213 receives measurement values from the acceleration sensors 240. For example, the sensor information reception unit 213 receives multiple measurement values measured by the acceleration sensors 240 while the AGV 200 is moving.

The sensor information reception unit 213 may be configured to receive measurement values from the acceleration sensors 240 by wireless communication, or may be configured to receive measurement values from the acceleration sensors 240 connected by wired communication.

The determination unit 214 determines whether or not an item loaded on the AGV 200 is being transported stably based on measurement values that are received by the sensor information reception unit 213 from the acceleration sensors 240.

For example, based on the received measurement values, the determination unit 214 acquires a maximum measurement value, which is the maximum measurement value of multiple measurement values and is a value corresponding to the degree of fluctuation of the measurement values. Moreover, the determination unit 214 calculates the degree of stability in stowage based on the degree of dispersion of the measurement values. For example, the determination unit 214 calculates the standard deviation of the measurement values as the degree of dispersion of the measurement values. Then, the determination unit 214 calculates the degree of stability in stowage by specifying a range to which the calculated degree of dispersion belongs of multiple predetermined ranges.

For example, through the process as described above, the determination unit 214 calculates the maximum measurement value and the degree of stability in stowage based on measurement values measured by the acceleration sensors 240. After that, the determination unit 214 determines whether or not an item loaded on the AGV 200 is being transported stably based on the calculated maximum measurement value and degree of stability in stowage and the model represented by the evaluation model 212. For example, the determination unit 214 performs the abovementioned determination by checking whether or not the intersection of the maximum measurement value and the degree of stability in stowage is within a model frame indicated by the evaluation model 212.

For example, in a case where, as shown in FIG. 6, the intersection (for example, a black circle in FIG. 6) of the maximum measurement value and the degree of stability in stowage is within the model frame indicated by the evaluation model 212, the determination unit 214 determines that the item is being transported stably. In this case, the determination unit 124 does not give warning in particular.

On the other hand, for example, in a case where, as shown in FIG. 7, the intersection (for example, a black circle in FIG. 7) of the maximum measurement value and the degree of stability in stowage is not within the model frame indicated by the evaluation model 212, the determination unit 214 determines that the item is not being transported stably. In this case, the determination unit 124 notifies its determination that the item is not being transported stably to the instability signal transmission unit 215.

The instability signal transmission unit 215 transmits an instability signal showing that the item is not being transported stably to the warning device 300 based on the notification from the determination unit 214. For example, the instability signal transmission unit 215 receives notification of the determination that the item is not being transported stably, from the determination unit 214. The instability signal transmission unit 215 then transmits the instability signal to the warning device 300.

For example, the instability signal transmission unit 215 has an antenna part. Transmission of the instability signal from the instability signal transmission unit 215 to the warning device 300 is performed by wireless communication via the antenna part. The instability signal transmission unit 215 may be configured to transmit the instability signal to the warning device 300 connected by wire.

An operator who operates the warning device 300 having received the instability signal reloads the item loaded on the AGV 200 in response to reception of the instability signal. Therefore, it can be said that the instability signal is a signal for instructing to reload the item.

The warning device 300 is, for example, a mobile terminal held by an operator who performs loading an item, and so on. The warning device 300 is a general information processing device that has a screen display unit, such as a tablet or a smartphone, for example. The warning device 300 may be an information processing device other than those illustrated above. Upon receiving the instability signal, the warning device 300 outputs information corresponding to the received instability signal.

FIG. 8 shows an example of the configuration of the warning device 300 that is characteristic to this example embodiment. Referring to FIG. 8, the warning device 300 includes, for example, an instability signal reception unit 310 and a display unit 320. The warning device 300 includes, for example, an arithmetic logic unit such as a CPU and a storage unit. The warning device 300 realizes the respective processing units by execution of a program stored in the storage unit by the arithmetic logic unit.

The instability signal reception unit 310 receives an instability signal from the AGV 200. For example, the instability signal reception unit 310 includes an antenna part. The instability signal reception unit 310 receives an instability signal by wireless communication via the antenna part.

The display unit 320 displays on screen information corresponding to the received instability signal. For example, the display unit 320 displays on screen the need for reloading the item in response to the received instability signal.

The warning device 300 may be configured to, in addition to displaying on screen or instead of displaying on screen, notify the operator that the instability signal has been received by voice or the like. Moreover, the warning device 300 may be configured to transmit reception of the instability signal to an external device.

Further, in a case where a control device such as a robot arm has the function as the warning device 300, the control device may be configured to automatically reload the item, in addition to displaying on screen the need for reloading the item or instead of displaying on screen the need for reloading the item.

The above is an example of the configuration of the AGV system 100. Next, referring to FIG. 9, an example of an operation when determining whether or not an item is being transported stably will be described.

Referring to FIG. 9, the sensor information reception unit 213 receives measurement values measured by the acceleration sensors 240 (step S101). For example, the sensor information reception unit 213 receives multiple measurement values measured by the acceleration sensors 240 when the AGV 200 moves.

The determination unit 214 calculates the maximum measurement value and the degree of stability in stowage based on the received measurement values (step S102).

The determination unit 214 compares the result of the calculation with a model represented by the evaluation model 212 (step S103).

In a case where the intersection of the maximum measurement value and the degree of stability in stowage is within a model frame represented by the evaluation model 212 (step S104, Yes), the determination unit 214 determines that the item is being transported stably. In this case, the determination unit 214 does not give warning in particular.

On the other hand, in a case where the intersection of the maximum measurement value and the degree of stability in stowage is not within the model frame represented by the evaluation model 212 (step S104, No), the determination unit 214 determines that the item is not being transported stably. In this case, the determination unit 214 notifies its determination that the item is not being transported stably to the instability signal transmission unit 215.

The instability signal transmission unit 215 transmits an instability signal indicating that the item is not being transported stably to the warning device 300 based on the notification from the determination unit 214 (step S105).

The instability signal reception unit 310 of the warning device 300 receives the instability signal. The display unit 320 of the warning device 300 then performs predetermined output such as displaying on screen information corresponding to the received instability signal (step S201).

Thus, the AGV main body 210 includes the evaluation model 212, the sensor information reception unit 213, and the determination unit 214. With such a configuration, the determination unit 214 can calculate the maximum measurement value and the degree of stability in stowage based on the measurement values received by the sensor information reception unit 213. As a result, the determination unit 214 can determine whether or not the item is being transported stably based on the calculated maximum measurement value and degree of stability in stowage and the model represented by the evaluation model 212. With this, it becomes possible to correctly determine the possibility of a transportation accident in a case where the AGV 200 moves with an item loaded. Moreover, it becomes possible to given an instruction to reload an item in a case where the possibility of a transportation accident is high, and consequently, it becomes possible to reduce the possibility of a transportation accident.

The configuration of the AGV main body 210 is not limited to the example shown in FIG. 3. For example, the AGV main body 210 can previously store a shake correction model 216 as shown in FIG. 10. The shake correction model 216 is a model for correcting a shake caused by movement of the AGV 200. For example, the shake correction model 216 is previously generated by learning values output from the acceleration sensors 240 in a state that an item is not loaded. In such a configuration, the determination unit 214 performs various calculations and determination processes after correcting the output received from the acceleration sensors 240 based on the shake correction model 216.

Further, although a case where the AGV 200 includes the acceleration sensors 240 has been illustrated in this example embodiment, the AGV 200 may have a sensor other than an acceleration sensor as long as it can express the instability of an item as a model. For example, the AGV 200 may include a sonic sensor, a magnet that measures the distance between the top board 230 and the AGV main body 210, or a distance measurement sensor, instead of including the acceleration sensor 240 or in addition to including the acceleration sensor 240.

Further, although a case where the degree of stability in stowage is also calculated based on output from the acceleration sensors 240 has been illustrated in this example embodiment, the degree of stability in stowage may be calculated by a method other than that illustrated in this example embodiment. For example, the degree of stability in stowage may be calculated based on the result of measurement by a sonic sensor, a magnet, or the like. Moreover, the degree of stability in stowage may be calculated based on the behavior of an item shown by image data captured by a camera that captures an image of the AGV 200. The degree of stability in stowage may be automatically determined based on the image data, or may be given by an operator who checks image data.

### Second Example Embodiment

Next, referring to FIG. 11, a second example embodiment of the present invention will be described. In the second example embodiment, the configuration of a determination device 40 will be described.

The determination device 40 is an information processing device that determines whether or not an item loaded on a transportation vehicle is being transported stably. FIG. 11 shows an example of the configuration of the determination device 40. Referring to FIG. 11, the determination device 40 includes, for example, a reception unit 41 and a determination unit 42.

The reception unit 41 receives a measurement value measured by a sensor mounted on a transportation vehicle.

The determination unit 42 determines whether or not an item is being transported stably by the transportation vehicle based on the degree of stability in stowage indicating the degree of stability of an item based on the transportation condition of the transportation vehicle, and based on the received measurement value.

Thus, the determination device 40 includes the reception unit 41 and the determination unit 42. With such a configuration, the determination device 40 can determine whether or not an item is being transported stably by a transportation vehicle based on the measurement value and the degree of stability in stowage indicating the degree of stability of the item. As a result, in a case where the AGV 200 moves with an item loaded, it is possible to correctly determine the possibility of a transportation accident.

Further, the determination device 40 described above can be implemented by installation of a predetermined program into the determination device 40. To be specific, a program according to another aspect of the present invention is a program including instructions for causing the determination device 40 that determines whether or not an item loaded on a transportation vehicle is being transported stably to implement: the reception unit 41 that receives a measurement value measured by a sensor mounted on the transportation vehicle; and the determination unit 42 that determines whether or not the item is being transported stably by the transportation vehicle based on the degree of stability in stowage indicating the degree of stability of an item based on the transportation condition of the transportation vehicle, and based on the received measurement value.

Further, a determination method executed by the determination device 40 described above is a determination method executed by the determination device 40 that determines whether or not an item loaded on a transportation vehicle is being transported stably. The determination method is a method including; receiving a measurement value measured by a sensor mounted on the transportation vehicle; and determining whether or not the item is being transported stably by the transportation vehicle based on the degree of stability in stowage indicating the degree of stability of the item and the received measurement value, based on the transportation condition of the transportation vehicle,.

The inventions of the program and the determination method having the configurations described above have the same actions and effects as the determination device 40 described above, and therefore, can also achieve the abovementioned object of the present invention. Moreover, a recording medium on which a program is recorded can also achieve the object of the present invention.

### <Supplementary Notes>

The whole or part of the example embodiments disclosed above can be described as the following supplementary notes. Below, the outline of the determination method according to the present invention will be described. However, the present invention is not limited to the following configurations.

### (Supplementary Note 1)

A determination method executed by a determination device that determines whether or not an item loaded on a transportation vehicle is being transported stably, the determination method comprising:

receiving measurement values measured by a sensor installed on the transportation vehicle; and

determining whether or not the item is being transported stably by the transportation vehicle based on a degree of stability in stowage representing a degree of stability of the item and based on the received measurement values, the degree of stability in stowage being based on a transportation condition of the transportation vehicle.

### (Supplementary Note 2)

The determination method according to Supplementary Note 1, wherein the degree of stability in stowage is calculated based on the received measurement values.

### (Supplementary Note 3)

The determination method according to Supplementary Note 1 or 2, wherein the degree of stability in stowage is calculated based on a degree of dispersion of the received measurement values.

### (Supplementary Note 4)

The determination method according to any one of Supplementary Note 1 to 3, wherein a maximum measurement value that is a maximum measurement value of the received measurement values is acquired and it is determined whether or not the item is being transported stably by the transportation vehicle based on the maximum measurement value and the degree of stability in stowage.

### (Supplementary Note 5)

The determination method according to any one of Supplementary Notes 1 to 4, wherein:

a previously learned evaluation model is prepared; and

it is determined whether or not the item is being transported stably by the transportation vehicle based on the evaluation model, the measurement values, and the degree of stability in stowage.

### (Supplementary Note 6)

The determination method according to Supplementary Note 5, wherein the evaluation model is previously learned based on the measurement values received from the sensor.

### (Supplementary Note 7)

The determination method according to any one of Supplementary Notes 1 to 6, comprising notifying to an external device that the item is not being transported stably in the case of determining that the item is not being transported stably.

### (Supplementary Note 8)

The determination method according to any one of Supplementary Notes 1 to 7, wherein the sensor is an acceleration sensor.

### (Supplementary Note 9)

A determination device determining whether or not an item loaded on a transportation vehicle is being transported stably, the determination device comprising:

a reception unit configured to receive measurement values measured by a sensor installed on the transportation vehicle; and

a determination unit configured to determine whether or not the item is being transported stably by the transportation vehicle based on a degree of stability in stowage representing a degree of stability of the item and based on the received measurement values, the degree of stability in stowage being based on a transportation condition of the transportation vehicle.

### (Supplementary Note 10)

A non-transitory computer-readable medium storing a program comprising instructions for causing a determination device determining whether or not an item loaded on a transportation vehicle is being transported stably to realize:

a reception unit configured to receive measurement values measured by a sensor installed on the transportation vehicle; and

a determination unit configured to determine whether or not the item is being transported stably by the transportation vehicle based on a degree of stability in stowage representing a degree of stability of the item and based on the received measurement values, the degree of stability in stowage being based on a transportation condition of the transportation vehicle.

The program described in the example embodiments and the supplementary notes is stored in a storage unit or recorded on a computer-readable recording medium. For example, the recording medium is a portable medium such as a flexible disk, an optical disk, a magneto-optical disk, or a semiconductor memory.

Although the present invention has been described above referring to the example embodiments, the present invention is not limited to the above example embodiments. The configurations and details of the present invention can be changed in various manners that can be understood by one skilled in the art within the scope of the present invention.

### DESCRIPTION OF REFERENCE NUMERALS

100 AGV system
200 AGV
210 AGV main body
211 model learning unit
212 evaluation model
213 sensor information reception unit
214 determination unit
215 instability signal transmission unit
220 top board lifter
230 top board
240 acceleration sensor
300 warning device
310 instability signal reception unit
320 display unit
40 determination device
41 reception unit
42 determination unit

1. A determination method executed by a determination device that determines whether or not an item loaded on a transportation vehicle is being transported stably, the determination method comprising:
receiving measurement values measured by a sensor installed on the transportation vehicle; and
determining whether or not the item is being transported stably by the transportation vehicle based on a degree of stability in stowage representing a degree of stability of the item and based on the received measurement values, the degree of stability in stowage being based on a transportation condition of the transportation vehicle.

2. The determination method according to claim 1, wherein the degree of stability in stowage is calculated based on the received measurement values.

3. The determination method according to claim 1, wherein the degree of stability in stowage is calculated based on a degree of dispersion of the received measurement values.

4. The determination method according to claim 1, wherein a maximum measurement value that is a maximum measurement value of the received measurement values is acquired and it is determined whether or not the item is being transported stably by the transportation vehicle based on the maximum measurement value and the degree of stability in stowage.

5. The determination method according to claim 1, wherein:
a previously learned evaluation model is prepared; and
it is determined whether or not the item is being transported stably by the transportation vehicle based on the evaluation model, the measurement values, and the degree of stability in stowage.

6. The determination method according to claim 5, wherein the evaluation model is previously learned based on the measurement values received from the sensor.

7. The determination method according to claim 1, comprising notifying to an external device that the item is not being transported stably in the case of determining that the item is not being transported stably.

8. The determination method according to claim 1, wherein the sensor is an acceleration sensor.

9. A determination device determining whether or not an item loaded on a transportation vehicle is being transported stably, the determination device comprising:
a reception unit configured to receive measurement values measured by a sensor installed on the transportation vehicle; and
a determination unit configured to determine whether or not the item is being transported stably by the transportation vehicle based on a degree of stability in stowage representing a degree of stability of the item and based on the received measurement values, the degree of stability in stowage being based on a transportation condition of the transportation vehicle.

10. A non-transitory computer-readable medium storing a program comprising instructions for causing a determination device determining whether or not an item loaded on a transportation vehicle is being transported stably to realize:
a reception unit configured to receive measurement values measured by a sensor installed on the transportation vehicle; and
a determination unit configured to determine whether or not the item is being transported stably by the transportation vehicle based on a degree of stability in stowage representing a degree of stability of the item and based on the received measurement values, the degree of stability in stowage being based on a transportation condition of the transportation vehicle.
